(19) United States
(12) Patent Application Publication
(10) Pub. No.: US 2007/0245389 A1
(43) Pub. Date: Oct. 18, 2007

(54) Playback apparatus and method of managing buffer of the playback apparatus

(76) Inventor: Shinji Kuno, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/726,342

(22) Filed: Mar. 21, 2007

(30) Foreign Application Priority Data
Mar. 22, 2006 (JP) 2006-078220

(51) Int. Cl. H04N 7/173

(52) U.S. Cl. 725/89; 725/134

(57) ABSTRACT

According to one embodiment, a playback apparatus includes a buffer to draw an object including operation guidance to be superposed on a main image, a graphics driver which controls allocation of an area in the buffer to a host program requesting drawing of the object, and a buffer managing unit configured to receive allocation of the area in the buffer from the graphics driver, and to allocate the allocated area to the host program, the buffer managing unit being interposed between the host program and the graphics driver.

### CROSS-REFERENCE TO RELATED APPLICATIONS

This application is based upon and claims the benefit of priority from Japanese Patent Application No. 2006-78220, filed Mar. 22, 2006, the entire contents of which are incorporated herein by reference.

### BACKGROUND

1. Field

One embodiment of the invention relates to a playback apparatus such as a High Definition Digital Versatile Disc (HD DVD) player, and a method of managing a buffer of the playback apparatus.

2. Description of the Related Art

Recently, with development of digital compression encoding technique of moving images, playback apparatuses (players) which can deal with high-definition images of High Definition (HD) standard have been developed.

Players of this type are required to have functions for merging a plurality of image data items at a high order to enhance interactivity.

For example, Jpn. Pat. Appln. KOKAI Pub. No. 8-205092 discloses a system which combines graphics data with video data by a display controller. In the system, the display controller captures video data, and combines the captured video data with part of an area of a graphics picture.

In the meantime, in conventional systems including the system disclosed in Jpn. Pat. Appln. KOKAI Pub. No. 8-205092 are predicated on dealing with video data of a relatively low definition, and not intended to deal with high-definition images such as video data of the HD standard. Further, they are not intended to superpose many image data items.

On the other hand, in the HD standard, it is required to interpret a script described with a markup language and included in a moving image stream, and properly display objects such as operation guidance during playback of main images, that is, it is required to realize high-level interactivity.

Generally, a dedicated buffer is provided to draw the objects. When many objects are displayed in turn while being frequently switched, there may be cases where available areas are scattered and an enough continuous available area cannot be secured, although there are enough available areas. To avoid such situations, a mechanism for efficiently allocate a buffer for drawing objects is strongly desired.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram illustrating a structure of a playback apparatus according to an embodiment of the present invention.

FIG. 2 is an exemplary diagram illustrating a structure of a player application used in the playback apparatus of FIG. 1.

FIG. 3 is an exemplary diagram illustrating a function and a structure of a software decoder realized by the player application of FIG. 2.

FIG. 4 is an exemplary diagram illustrating blend processing executed by a blend processing unit provided in the playback apparatus of FIG. 1.

FIG. 5 is an exemplary diagram illustrating blend processing executed by a GPU provided in the playback apparatus of FIG. 1.

FIG. 6 is an exemplary diagram illustrating a state where sub video data is displayed in a state of being superposed on main video data in the playback apparatus of FIG. 1.

FIG. 7 is an exemplary diagram illustrating a state where main video data is displayed in a part of area on sub video data in the playback apparatus of FIG. 1.

FIG. 8 is an exemplary conceptual diagram illustrating a processing for superposing a plurality of image data items in AV content of the HD standard in the playback apparatus of FIG. 1.

FIG. 9 is an exemplary diagram illustrating an operation principle of a pixel buffer manager in the playback apparatus of FIG. 1.

### DETAILED DESCRIPTION

Various embodiments according to the invention will be described hereinafter with reference to the accompanying drawings. In general, according to one embodiment of the invention, a playback apparatus includes a buffer to draw an object including operation guidance to be superposed on a main image, a graphics driver which controls allocation of an area in the buffer to a host program requesting drawing of the object, and a buffer managing unit configured to receive allocation of the area in the buffer from the graphics driver, and to allocate the allocated area to the host program, the buffer managing unit being interposed between the host program and the graphics driver.

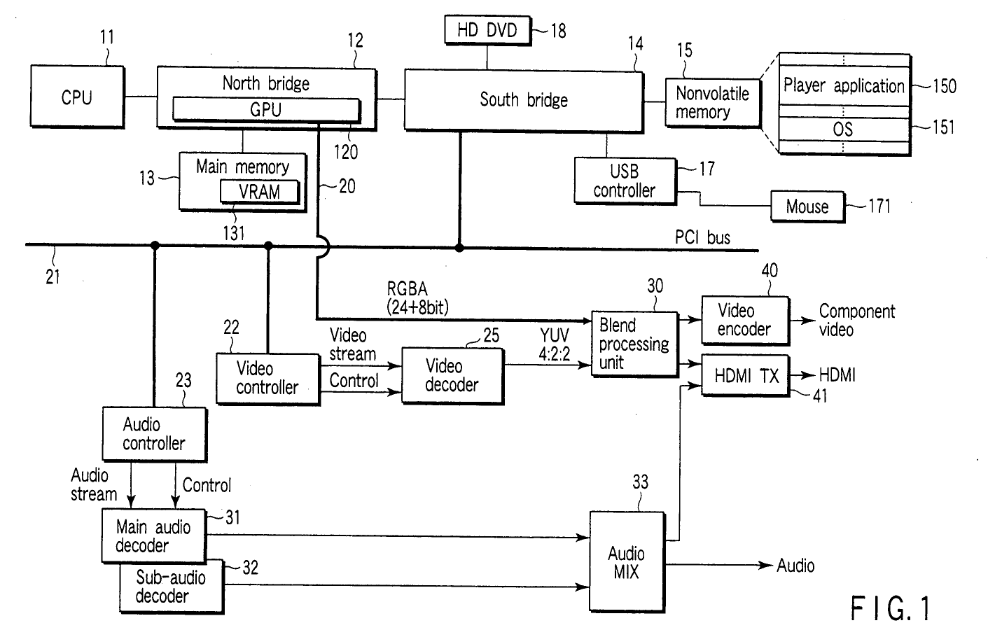

FIG. 1 illustrates an example of a structure of a playback apparatus according to an embodiment of the present invention. The playback apparatus is a media player which plays back audiovisual (AV) content. The playback apparatus is realized as an HD DVD player which plays back AV content stored in a DVD medium of the High-Definition Digital Versatile Disc (HD DVD) standard.

As shown in FIG. 1, the HD DVD player comprises a Central Processing Unit (CPU) 11, a north bridge 12, a main memory 13, a south bridge 14, a nonvolatile memory 15, a Universal Serial Bus (USB) controller 17, an HD DVD drive 18, a graphics bus 20, a Peripheral Component Interconnect (PCI) bus 21, a video controller 22, an audio controller 23, a video decoder 25, a blend processing unit 30, a main audio decoder 31, a sub-audio decoder 32, an audio mixer (Audio Mix) 33, a video encoder 40, and an AV interface (HDMI-TX) 41 such as a High-Definition Multimedia Interface (HDMI).

In the HD DVD player, a player application 150 and an operating system (OS) 151 are installed in advance in the nonvolatile memory 15. The player application 150 is software operating on the OS 151, and performs control to play back AV content read by the HD DVD drive 18.

AV content stored in a storage medium, such as an HD DVD medium, driven by the HD DVD drive 18 comprises compressed and encoded main video data, compressed and encoded main audio data, compressed and encoded sub-video data, compressed and encoded sub-picture data, graphic data containing alpha data, compressed and encoded sub-audio data, and navigation data which controls playback of the AV content.

The compressed and encoded main video data is data obtained by compressing and encoding moving image data, to be used as main images (main picture images) with compression encoding method of the H.264/AVC standard. The main video data comprises high-definition images of the HD standard. Video data of the Standard Definition (SD) standard may be used as the main video data. The compressed and encoded main audio data is audio data associated with the main video data. The main audio data is played back in synchronization with playback of the main video data.

The compressed and encoded sub-video data is formed of subsidiary images (sub-picture images) displayed in a state of being superposed on the main video images, and comprises moving images (for example, images of an interview scene of a director of a movie serving as the main video image) which supplement the main video data. The compressed and encoded sub-audio data is audio data associated with the sub-video data. The sub-audio data is played back in synchronization with playback of the sub-video data.

The graphics data is also formed of subsidiary images (sub-picture images) displayed in a state of being superposed on the main video images, and comprises various data (Advanced Elements) for displaying operation guidance such as menu objects. Each of the advanced elements is formed of still images, moving images (including animation), and texts. The player application 150 has a drawing function for drawing pictures in accordance with mouse operations by the user. Images drawn by the drawing function are also used as graphics data, and can be displayed in a state of being superposed on the main video images.

The compressed and encoded sub-picture data is formed of texts such as subtitles.

The navigation data includes a play list for controlling the playback order of the content, and a script for controlling playback of the sub-video data and graphics (advanced elements). The script is described by a markup language such as XML.

The main video data of the HD standard has a resolution of 1920×1080 pixels, or 1280×720 pixels. Further, each of the sub-video data, the sub-picture data, and the graphics data has a resolution of, for example, 720×480 pixels.

In the HD DVD player, the software (the player application 150) performs a separation processing and a decoding processing. In the separation processing, the main video data, the main audio data, the sub-video data, the sub-audio data, and the sub-picture data are separated from an HD DVD stream read by the HD DVD drive 18. In the decoding processing, the sub-video data, the sub-picture data, and the graphics data are decoded. On the other hand, the hardware performs processing requiring much processing amount, that is, processing of decoding the main video data, and decoding processing of decoding the main audio data and the sub-audio data.

The CPU 11 is a processor provided to control operation of the HD DVD players. The CPU 11 executes the OS 151 and the player application 150 that are loaded from the nonvolatile memory 15 to the main memory 13. A part of a storage area in the main memory 13 is used as a video memory (VRAM) 131. However, it is not indispensable to use a part of the storage area in the main memory 13 as the VRAM 131. A dedicated memory device independent of the main memory 13 may be used as the VRAM 131.

The north bridge 12 is a bridge device that connects a local bus of the CPU 11 with the south bridge 14. The north bridge 12 includes a memory controller which performs access control of the main memory 13. Further, the north bridge 12 also includes a Graphics Control Unit (GPU) 120.

The GPU 120 is a graphics controller that generates a graphics signal, which forms a graphics picture image, from data written by the CPU 11 in the video memory (VRAM) 131 being a part of the storage area of the main memory 13. The GPU 120 generates a graphics signal by using a graphics computing function such as bit block transfer. For example, suppose that the CPU 11 writes image data items (sub-video, sub-picture, graphics, and cursor) in four respective planes on the VRAM 131. The GPU 120 executes, by using bit block transfer, blend processing to superpose the image data items of the four planes pixel by pixel, and thereby generates a graphics signal to form a graphics picture image having the same resolution (for example, 1920×1080 pixels) of that of the main video. The blend processing is executed by using respective alpha data items corresponding to the sub-video, the sub-picture, and the graphics. Alpha data is a coefficient indicating transparency (or opacity) of each pixel of the image data corresponding to the alpha data. The respective alpha data items corresponding to the sub-video, the sub-picture, and the graphics are stored in the HD DVD medium together with the respective image data items of the sub-video, the sub-picture, and the graphics. Specifically, each of the sub-video, the sub-picture, and the graphics is formed of image data and alpha data.

A graphics signal generated by the GPU 120 has an RGB color space. Each pixel of a graphics signal is expressed by digital RGB data (24 bits).

Besides generating a graphics signal forming a graphic picture image, the GPU 120 also has a function of outputting alpha data corresponding to the generated graphics signal to the outside.

Specifically, the GPU 120 outputs a generated graphics signal to the outside as a digital RGB video signal, and also outputs alpha data corresponding to the generated graphics signal to the outside. The alpha data is a coefficient (8 bits) indicating transparency (or opacity) of each pixel of the generated graphics signal (RGB data). The GPU 120 outputs, for each pixel, graphics output data with alpha data (RGBA data of 32 bits), formed of a graphics signal (a digital RGB video signal of 24 bits) and alpha data (8 bits). The graphics output data with alpha data (RGBA data of 32 bits) is sent to the blend processing unit 30 through the dedicated graphics bus 20. The graphics bus 20 is a transmission line that connects the GPU 120 with the blend processing unit 30.

As described above, in the HD DVD player, graphics output data with alpha data is directly transmitted from the GPU 120 to the blend processing unit 30 through the graphics bus 20. This makes unnecessary to transmit alpha data from the VRAM 131 to the blend processing unit 30 by using the PCI bus 21 or the like, and therefore prevents increase in the traffic of the PCI bus 21 due to transmission of alpha data.

If alpha data is transmitted from the VRAM 131 to the blend processing unit 30 through the PCI bus 21 or the like, it is required to synchronize the graphics signal output from the GPU 120 and alpha data transmitted through the PCI bus 21, and thereby the structure of the blend processing unit 30 is complicated. In the HD DVD player of the present invention, the GPU 120 outputs graphics signals and the alpha data in synchronization with each other pixel by pixel. Therefore, synchronization between graphics signals and alpha data is easily achieved.

The south bridge 14 controls the devices arranged on the PCI bus 21. The south bridge 14 includes an Integrated Drive Electronics (IDE) controller to control the HD DVD drive 18. The south bridge 14 also has a function of controlling the nonvolatile memory 15 and the USB controller 17. The USB controller 17 controls a mouse device 171. The user can select a menu item and the like by operating the mouse device 171. A remote control unit may be used instead of the mouse device 171 as a matter of course.

The HD DVD drive 18 is a drive unit to drive storage media, such as HD DVD media storing AV content compliant with the HD DVD standard.

The video controller 22 is connected to the PCI bus 21. The video controller 22 is an LSI that interfaces with the video decoder 25. A stream (Video Stream) of main video data separated from an HD DVD stream by the software is transmitted to the video decoder 25 through the PCI bus 21 and the video controller 22. Further, decode control information (Control) output from the CPU 11 is also transmitted to the video decoder 25 through the PCI bus 21 and the video controller 22.

The video decoder 25 is a decoder compliant with the H.264/AVC standard. The video decoder 25 decodes main video data of the HD standard and generates a digital YUV video signal that forms a video picture image with a resolution of, for example, 1920×1080 pixels. The digital YUV video signal is transmitted to the blend processing unit 30.

The blend processing unit 30 is connected to the GPU 120 and the video decoder 25, and executes blend processing to superpose graphics output data output from the GPU 120 and main video data decoded by the video decoder 25. In the blend processing, blend processing (alpha blending processing) is performed to superpose a digital RGB video signal forming graphics data and a digital YUV video signal forming main video data pixel by pixel, on the basis of alpha data output from the GPU 120 together with the graphics data (RGB). In the processing, the main video data is used as an underside picture image, and the graphics data is used as a top picture image superposed on the main video data.

Output image data obtained by blending processing is supplied to each of the video encoder 40 and the AV interface (HDMI-TX) 41, as a digital YUV video signal, for example. The video encoder 40 converts output image data (digital YUV video signal) obtained by blend processing into a component video signal or an S-video signal, and outputs it to an external display device (monitor) such as a television set. The AV interface (HDMI-TX) 41 outputs a set of digital signals containing the digital YUV video signal and a digital audio signal to an external HDMI device.

The audio controller 23 is connected to the PCI bus 21. The audio controller 23 is an LSI that interfaces with each of the main audio decoder 31 and the sub-audio decoder 32. A main audio data stream separated from an HD DVD stream by the software is transmitted to the main audio decoder 31 through the PCI bus 21 and the audio controller 23. Further, a sub-audio data stream separated from an HD DVD stream by the software is transmitted to the sub-audio decoder 32 through the PCI bus 21 and the audio controller 23. Decoding control information (Control) output from the CPU 11 is also supplied to each of the main audio decoder 31 and the sub-audio decoder 32 through the video controller 22.

The main audio decoder 31 generates a digital audio signal of Inter-IC Sound (I2S) format by decoding main audio data. The digital audio signal is transmitted to the audio mixer (Audio Mix) 33. The main audio data is compressed and encoded by using any one of a plurality of types of predetermined compression encoding methods (that is, a plurality of types of audio codecs). Therefore, the main audio decoder 31 has decoding functions compliant with the respective compression encoding methods. Specifically, the main audio decoder 31 generates a digital audio signal by decoding main audio data compressed and encoded with one of the compression encoding methods. The main audio decoder 31 is notified of the type of the compression encoding method used for the main audio data, by the decoding control information from the CPU 11.

The sub-audio decoder 32 generates a digital audio signal of the Inter-IC Sound (I2S) format by decoding sub-audio data. The digital audio data is transmitted to the audio mixer (Audio Mix) 33. The sub-audio data is also compressed and encoded by using any one of the above predetermined compression encoding methods (that is, a plurality of types of audio codecs). Therefore, the sub-audio decoder 32 also has decoding functions compliant with the respective compression encoding methods. Specifically, the sub-audio decoder 32 generates a digital audio signal by decoding sub-audio data compressed and encoded with one of the compression encoding methods. The sub-audio decoder 32 is notified of the type of the compression encoding method used for the sub-audio data, by the decoding control information from the CPU 11.

The audio mixer (Audio Mix) 33 generates a digital audio output signal, by executing mixing processing to mix main audio data decoded by the main audio decoder 31 with sub-audio data decoded by the sub-audio decoder 32. The digital audio output signal is transmitted to the AV interface (HDMI-TX) 41, and output to the outside after being converted into an analog audio output signal.

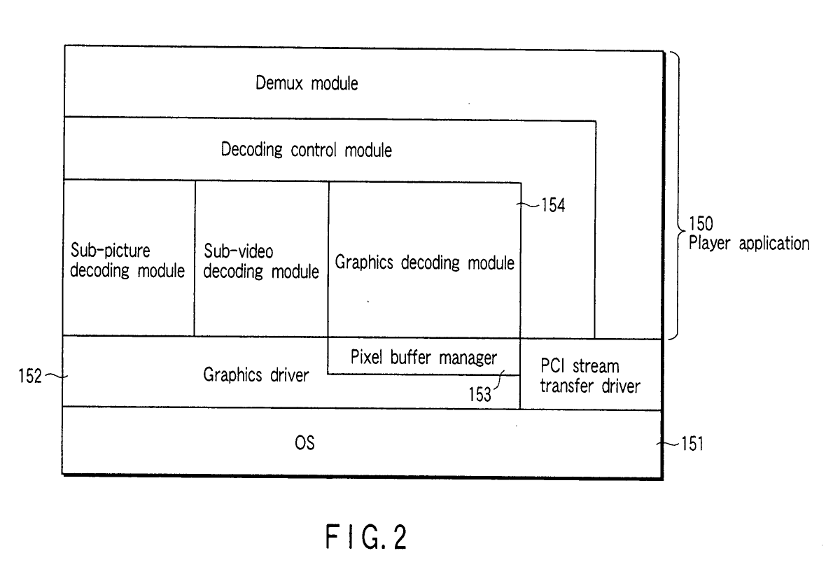

Next, a function and a structure of the player application 150 executed by the CPU 11 are explained with reference to FIG. 2.

The player application 150 comprises a demultiplex (Demux) module, a decoding control module, a sub-picture (Sub-Picture) decoding module, a sub-video (Sub-Video) decoding module, and a graphics decoding module 154.

The Demux module is software which executes demultiplex processing to separate main video data, main audio data, sub-picture data, sub-video data, and sub-audio data from a stream read by the HD DVD drive 18. The decoding control module is software which controls decoding processing of each of main video data, main audio data, sub-picture data, sub-video data, sub-audio data, and graphics data on the basis of navigation data.

The sub-picture decoding module decodes sub-picture data. The sub-video decoding module decodes sub-video data. The graphics decoding module 154 decodes graphics data (Advanced Elements).

A graphics driver 152 is software to control the GPU 120. Decoded sub-picture data, decoded sub-video data, and decoded graphics data are transmitted to the GPU 120 through the graphics driver 152. Further, the graphics driver 152 issues various drawing commands to the GPU120.

The graphics driver 152 manages a pixel buffer provided as a work area for drawing pictures by mouse operation and drawing objects such as operation guidance. The graphics decoding module 154 receives allocation of areas in the pixel buffer from the graphics driver 152, and generates various objects. In the HD DVD driver, a pixel buffer manager 153 is interposed between the graphics driver 152 and the graphics decoding module 154, to perform allocation control of the pixel buffer more efficiently. An operation principle of the pixel buffer manager 153 is described later.

A PCI stream transfer driver is software to transfer a stream through the PCI bus 21. Main video data, main audio data, and sub-audio data are transmitted to the video decoder 25, the main audio decoder 31, and the sub-audio decoder 32, respectively, through the PCI bus 21 by the PCI stream transfer driver.

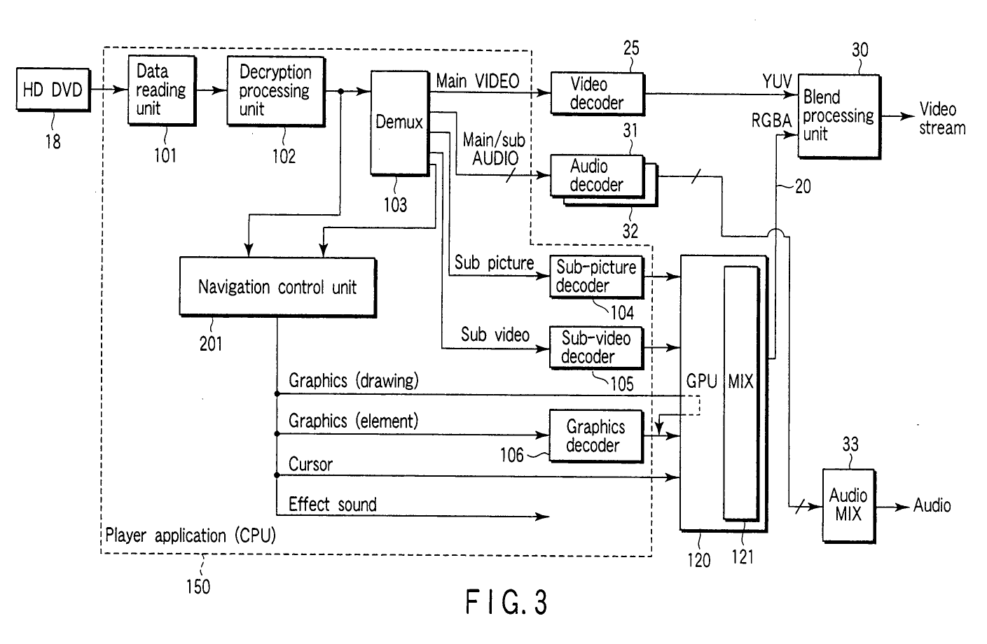

Next, a function and a structure of a software decoder realized by the player application 150 executed by the CPU 11 are explained with reference to FIG. 3.

As shown in FIG. 3, the software decoder comprises a data reading unit 101, a decryption processing unit 102, a demultiplex (Demux) unit 103, a sub-picture decoder 104, a sub-video decoder 105, a graphics decoder 106, and a navigation control unit 201.

Content (main video data, sub-video data, sub-picture data, main audio data, sub-audio data, graphics data, and navigation data) stored in an HD DVD medium in the HD DVD 18 is read from the HD DVD drive 18 by the data reading unit 101. Each of the main video data, the sub-video data, the sub-picture data, the main audio data, the sub-audio data, the graphics data, and the navigation data is encrypted. The main video data, the sub-video data, the sub-picture data, the main audio data, and the sub-audio data are superposed on an HD DVD stream. Each of the main video data, the sub-video data, the sub-picture data, the main audio data, the sub-audio data, the graphics data, and the navigation data read from the HD DVD medium by the data reading unit 101 is input to the content decryption processing unit 102. The decryption processing unit 102 executes processing to decrypt each of the encrypted data items. The decrypted navigation data is transmitted to the navigation control unit 201. Further, the decrypted HD DVD stream is transmitted to the demultiplex (Demux) unit 103.

The navigation control unit 201 analyses a script (XML) included in the navigation data, and controls playback of the graphics data (Advanced Elements). The graphics data (Advanced Elements) is transmitted to the graphics decoder 106. The graphics decoder 106 is formed of the graphics decoding module of the player application 150, and decodes the graphics data (Advanced Elements).

Further, the navigation control unit 201 also executes processing to move the cursor in response to the operation of the mouse device 171 by the user, and processing to play back sound effects in response to selection of a menu item. Drawing of an image by the above drawing function is achieved by the following: the navigation control unit 201 receives user's operation of the mouse device 171, causes the GPU 120 to generate graphics data of a picture formed by the path, that is, the cursor path, and thereafter input the data again to the GPU 120 as graphics data equivalent to graphics data decoded by the graphics decoder 106 by using navigation data.

The Demux 103 is realized by the Demux module of the player application 150. The Demux 103 separates the main video data, the main audio data, the sub-audio data, the sub-picture data, and the sub-video data from the HD DVD stream.

The main video data is transmitted to the video decoder 25 through the PCI bus 21. The main video data is decoded by the video decoder 25. The decoded main video data has a resolution of, for example, 1920×1080 pixels of the HD standard, and is transmitted as a digital YUV video signal to the blend processing unit 30.

The main audio data is transmitted to the main audio decoder 31 through the PCI bus 21. The main audio data is decoded by the main audio decoder 31. The decoded main audio data is transmitted as a digital audio signal of I2S format to the audio mixer 33.

The sub-audio data is transmitted to the sub-audio decoder 32 through the PCI bus 21. The sub-audio data is decoded by the sub-audio decoder 32. The decoded sub-audio data is transmitted as a digital audio signal of I2S format to the audio mixer 33.

The sub-picture data and the sub-video data are transmitted to the sub-picture decoder 104 and the sub-video decoder 105, respectively. The sub-picture decoder 104 and the sub-video decoder 105 decode the sub-picture data and the sub-video data, respectively. The sub-picture decoder 104 and the sub-video decoder 105 are achieved by the sub-picture decoding module and the sub-video decoding module of the player application 150, respectively.

The sub-picture data, the sub-video data, and the graphics data decoded by the sub-picture decoder 104, the sub-video decoder 105, and the graphics decoder 106, respectively, are written in the VRAM 131 by the CPU 11. Further, cursor data corresponding to a cursor image is also written in the VRAM 131 by the CPU 11. Each of the sub-picture data, the sub-video data, the graphics data, and the cursor data includes RGB data and alpha data (A) for each pixel.

The GPU 120 generates graphics output data, which forms a graphics picture image of 1920×1080 pixels, from the sub-video data, the graphics data, the sub-picture data, and the cursor data written in the VRAM 131 by the CPU 11. The sub-video data, the graphics data, the sub-picture data and the cursor data are superposed pixel by pixel, by alpha blending processing executed by the mixer (MIX) unit 121 of the GPU 120.

In the alpha blending processing, respective alpha data items corresponding to the sub-video data, the graphics data, the sub-picture data, and the cursor data written in the VRAM 131 are used. Specifically, each of the sub-video data, the graphics data, the sub-picture data, and the cursor data written in the VRAM 131 comprises image data and alpha data. The mixer (MIX) unit 121 executes blend processing on the basis of the respective data items corresponding to the sub-video data, the graphics data, the sub-picture data and the cursor data, and respective position information items of the sub-video data, the graphics data, the sub-picture data, and the cursor data designated by the CPU 11. Thereby, the mixer unit 121 generates a graphics picture image in which the sub-video data, the graphics data, the sub-picture data, and the cursor data are superposed on a background image of 1920×1080 pixels.

An alpha value of each pixel of the background image is a value indicating the pixel is transparent, that is, 0. In the graphics picture image, for areas in which image data items are superposed, new alpha data items corresponding to the respective areas are calculated by the mixer (MIX) unit 121.

As described above, the GPU 120 generates graphics output data (RGB), which forms a graphics picture image of 1920×1080 pixels, and alpha data corresponding to the graphics data, from the sub-video data, the graphics data, the sub-picture data, and the cursor data. When only one image of the sub-video data, the graphics data, the sub-picture data, and the cursor data is displayed, the GPU 120 generates graphics data corresponding to a graphics picture image, in which only the image (for example, 720×480) is disposed on a background image of 1920×1080 pixels, and generates alpha data corresponding to the graphics data.

The graphics data (RGB) and the alpha data generated by the GPU 120 are transmitted as RGBA data to the blend processing unit 30 through the graphics bus 20.

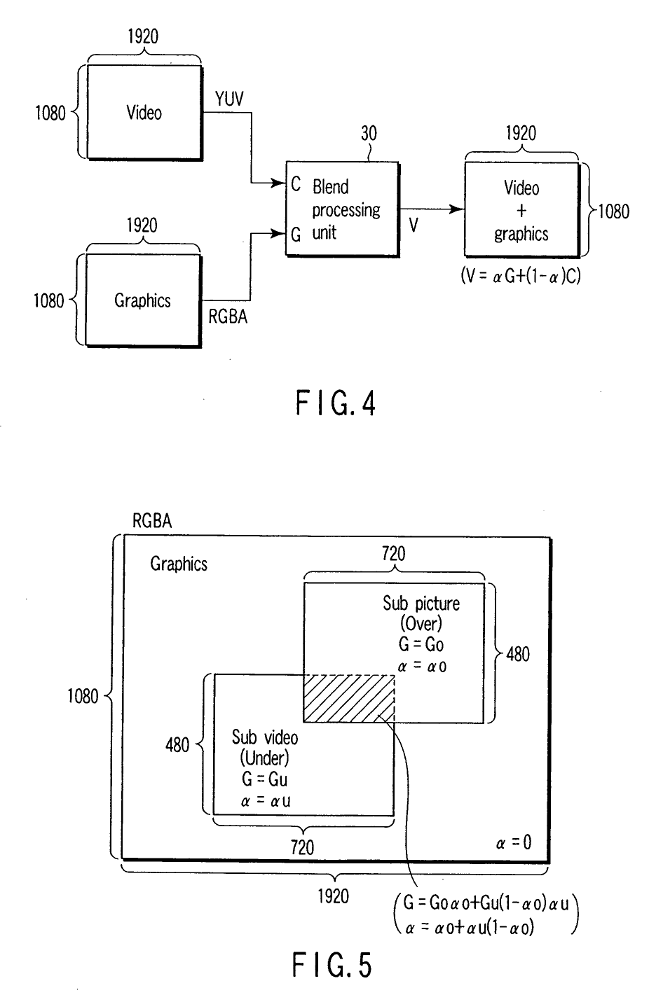

Next, the blend processing (alpha blending processing) executed by the blend processing unit 30 is explained with reference to FIG. 4.

Alpha blending processing is a blend processing in which graphics data and main video data are superposed pixel by pixel, on the basis of alpha data (A) accompanying the graphics data (RGB). The graphics data (RGB) is used as an oversurface image, and superposed on the video data. The resolution of graphics data output from the GPU 120 is the same as the resolution of main video data output from the video decoder 25.

Suppose that main video data (Video) having a resolution of 1920×1080 pixels is input to the blend processing unit 30 as image data C, and graphics data having a resolution of 1920×1080 pixels is input to the blend processing unit 30 as image data G. The blend processing unit 30 executes computation to superpose the image data G on the image data C pixel by pixel on the basis of alpha data (A) having a resolution of 1920×1080 pixels. This computation is executed by the following formula (1).

V=α×G+(1−α)C (1)

V denotes a color of each pixel of output image data obtained by alpha blending processing, and a denotes an alpha value corresponding to each pixel of the graphics data G.

Next, the blending processing (alpha blending processing) executed by the MIX unit 121 of the GPU 120 is explained with reference to FIG. 5.

In this embodiment, suppose that graphics data having a resolution of 1920×1080 pixels is generated from sub-picture data and sub-video data written in the VRAM 131. Each of the sub-picture data and the sub-video data has a resolution of, for example, 720×480 pixels. Each of the sub-picture data and the sub-video data is accompanied with alpha data having a resolution of 720×480 pixels.

For example, an image corresponding to the sub-picture data is used as an oversurface image, and an image corresponding to the sub-video data is used as an underface image.

A color of each pixel in an area where the image corresponding to the sub-picture data is superposed on the image corresponding to the sub-video data is determined by the following formula (2).

G=Go×αo+Gu(1−αo)αu (2)

G denotes a color of each pixel in the superposed area, Go denotes a color of each pixel of the sub-picture data used as the oversurface image, αo denotes an alpha value of each pixel of the sub-picture data used as the oversurface image, and Gu denotes a color of each pixel of the sub-video data used as an underface image.

Further, an alpha value of each pixel in an area where the image corresponding to the sub-picture data is superposed on the image corresponding to the sub-video data is determined by the following formula (3).

α=αo+αu(1−αo) (3)

α denotes an alpha value of each pixel of the superposed area, and αu denotes an alpha value of each pixel of sub-video data used as an undersurface.

As described above, the MIX unit 121 of the GPU 120 superposes sub-picture data and sub-video data, by using alpha data of data used as an oversurface image, among the alpha data corresponding to the sub-picture data and alpha data corresponding to the sub-video data, and thereby generates graphics data that forms a picture image of 1920×1080 pixels. Further, the MIX unit 121 of the GPU 120 calculates an alpha value of each pixel of the graphics data forming a picture image of 1920×1080 pixels, on the basis of the alpha data corresponding to the sub-picture data and the alpha data corresponding to the sub-video data.

Specifically, the MIX unit 121 of the GPU 120 executes blend processing of superposing a surface (color of pixels=black, alpha value of pixels=0) of 1920×1080 pixels, a surface of sub-video data of 720×480 pixels, and a surface of sub-picture data of 720×480 pixels, and thereby calculates graphics data forming a picture image of 1920×1080 pixels and alpha data of 1920×1080 pixels. The surface of 1920×1080 pixels is used as an undermost surface, the surface of the sub-video data is used as a second lowest surface, and the surface of the sub-picture data is used as an uppermost surface.

In the picture image of 1920×1080 pixels, the color of pixels in an area where neither of sub-picture data or sub-video data exists is black. Further, colors of pixels in an area where only sub-picture data exists are the same as respective original colors of corresponding pixels of the sub-picture data. In the same manner, colors of pixels in an area where only sub-video data exists are the same as respective original colors of corresponding pixels of the sub-picture data.

Further, in the picture image of 1920×1080 pixels, an alpha value corresponding to pixels in an area where neither of sub-picture data and sub-video data exists is 0. An alpha value of pixels in an area where only sub-picture data exists is the same as an original alpha value of corresponding pixels of the sub-picture data. In the same manner, an alpha value of pixels of an area where only sub-video data exists is the same as an original alpha value of corresponding pixels of the sub-video data.

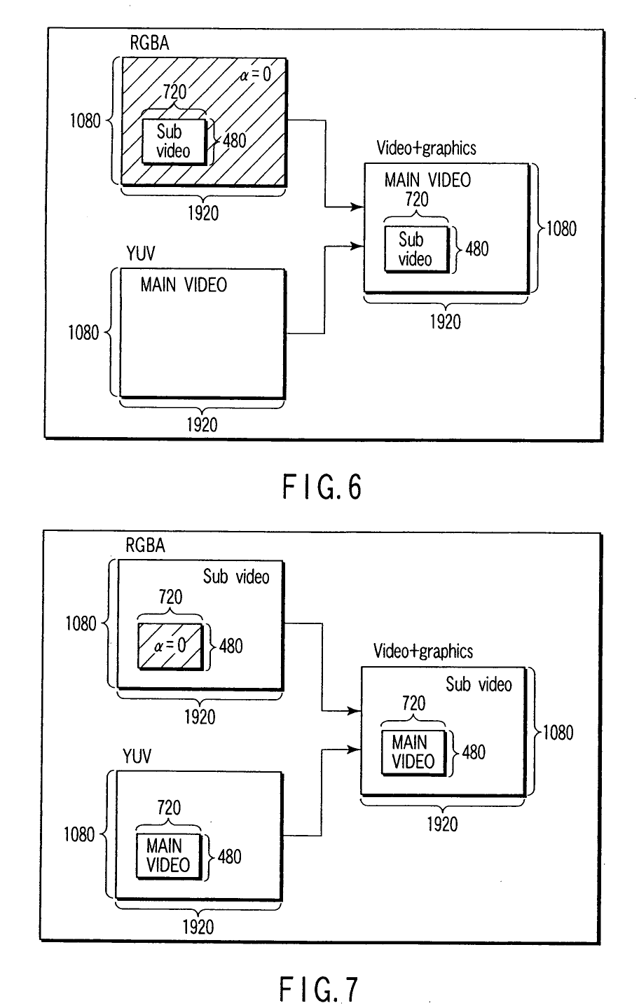

FIG. 6 illustrates a state where sub-video data of 720×480 pixels is displayed in a state of being superposed on main video data of 1920×1080 pixels.

In FIG. 6, graphics data is generated by blending processing of superposing a surface of 1920×1080 pixels (color of pixels=black, alpha value of pixels=0) and a surface of sub-video data of 720×480 pixels pixel by pixel.

As described above, output picture data (Video+Graphics) output to the display device is generated by blending graphics data with main video data.

In graphics data of 1920×1080 pixels, an alpha value of pixels in an area where sub video data of 720×480 pixels does not exist is 0. Therefore, the area where sub-video data does not exist is transparent, and the main video data with an opacity of 100% is displayed in the area.

Each pixel of the sub-video data of 720×480 pixels is displayed, with a transparency designated by the alpha data corresponding to the sub-video data, on the main video data. For example, pixels of sub-video data having an alpha value of 1 is displayed with an opacity of 100%, and pixels of main video data corresponding to the pixel positions of the sub-video data are not displayed.

Further, as shown in FIG. 7, main video data reduced to a resolution of 720×480 pixels can be displayed on an area on sub-video data enlarged to a resolution of 1920×1080 pixels.

The display mode of FIG. 7 is achieved by using a scaling function of the GPU 20 and a scaling function of the video decoder 25.

Specifically, in accordance with an instruction from the CPU 11, the GPU 20 performs scaling processing to increase the resolution of the sub-video data in a step-by-step manner until the resolution (image size) of the sub-video data reaches 1920×1080 pixels. The scaling processing is executed, using pixel interpolation. As the resolution of the sub-video data increases, an area where the sub-video data does not exist (the area having an alpha value of 0) gradually decreases in the graphics data of 1920×1080 pixels. Therefore, the size of the sub-video data displayed on the main video data gradually increases, and the area having an alpha value of 0 gradually decreases. When the resolution (image size) of the sub-video data reaches 1920×1080 pixels, the GPU 120 executes blending processing to superpose a surface (color of pixels=black, alpha value of pixels=0) of 720×480 pixels on the sub-video data of 1920×1080 pixels, and thereby disposes an area of 720×480 pixels with an alpha value of 0 on the sub-video data of 1920×1080 pixels.

On the other hand, the video decoder 25 executes scaling processing to reduce the resolution of the main video data to 720×480 pixels, in accordance with an instruction from the CPU 11.

The main video data reduced to 720×480 pixels is displayed in the area of 720×480 pixels, with an alpha value of 0, disposed on the sub-video data of 1920×1080 pixels. Specifically, alpha data output from the GPU 120 can also be used as a mask to limit the area in which the main video data is displayed.

As described above, alpha data output from the GPU 120 can be controlled by software. Thereby, graphics data is effectively displayed in a state of being superposed on main video data, and thereby highly interactive image display is easily realized. Further, alpha data is automatically transferred together with the graphics data from the GPU 120 to the blend processing unit 30, the software does not need to separately perform processing to transfer alpha data to the blend processing unit 30.

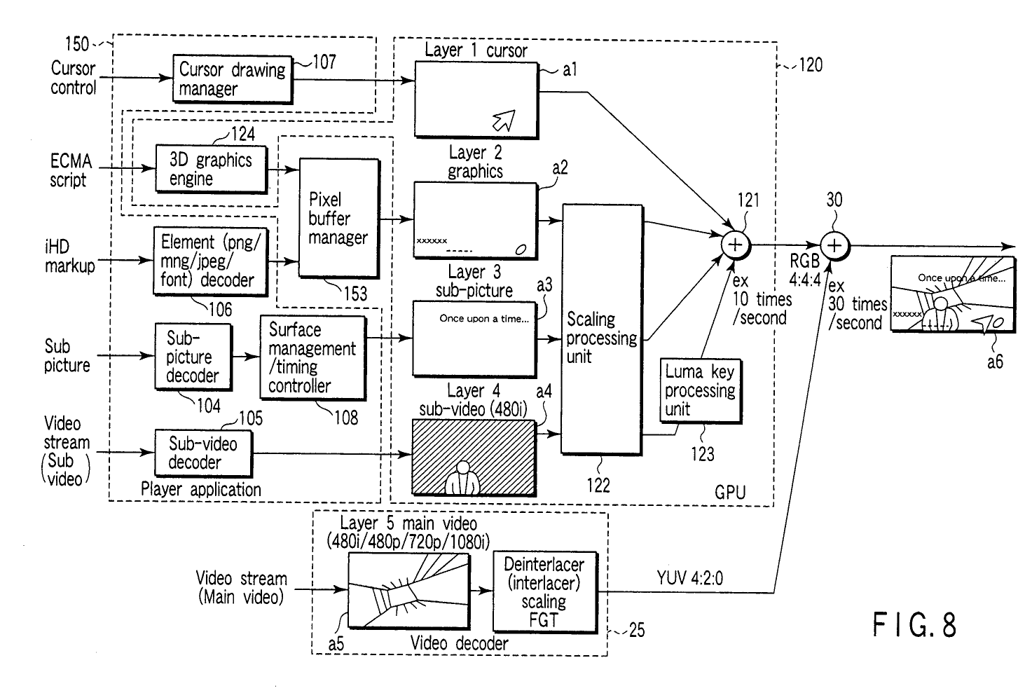

FIG. 8 is an exemplary conceptual diagram illustrating a process of superposing a plurality of image data items in HD standard AV content, played back by the HD DVD player, by the GPU 120 and the blend processing unit 30 operating as described above.

In the HD standard, five layers of Layer 1 to Layer 5 are defined, and the cursor, the graphics, the sub-picture, the sub-video, and the main video are allocated to Layers 1 to 5, respectively. As shown in FIG. 8, the mixer unit 121 of the GPU 120 superposes four images a1 to a4 of Layers 1 to 4 among the Layers 1 to 5, as a former-step processing, and the blend processing unit 30 superposes the image output from the GPU 120 and an image a5 of Layer 5, as a latter-step processing. Thereby, an object image a6 is generated.

The cursor, the graphics, the sub-picture, and the sub-video of Layers 1 to 4 are supplied from the player application 150 to the GPU 120. To supply the image data items to the GPU 120, the player application 150 comprises the sub-picture decoder 104, the sub-video decoder 105, the graphics decoder (element decoder) 106, and a cursor drawing manager 107, and a surface management/timing controller 108, as shown in FIG. 8.

The cursor drawing manager 107 is realized as a function of the navigation control unit 201, and executes cursor drawing control to move the cursor in response to user's operation of the mouse device 171. On the other hand, the surface management/timing controller 108 executes timing control to display images of sub-picture data decoded by the sub-picture decoder 104 at a proper timing.

Cursor control shown in FIG. 8 is control data for moving the cursor, which is generated by the USB controller 17 in response to operation of the mouse device 171. ECMA Script is a script in which a drawing API to instruct drawing of a point, a line, and a figure and the like is described. iHD Markup is text data described with a markup language to display various advanced elements at proper timings.

Further, the GPU 120 has a scaling processing unit 122, a luma key processing unit 123, and a 3D graphics engine 124, in addition to the mixer unit 121.

The scaling processing unit 122 executes the scaling processing mentioned in the explanation of FIG. 7. The luma key processing unit 123 executes luma key processing to remove the background (black) in the image by setting an alpha value of pixels, whose brightness value is less than a threshold value, to 0. The 3D graphics engine 124 executes graphics data generation processing, including image generation (of an image formed of a path of the cursor) for the drawing function.

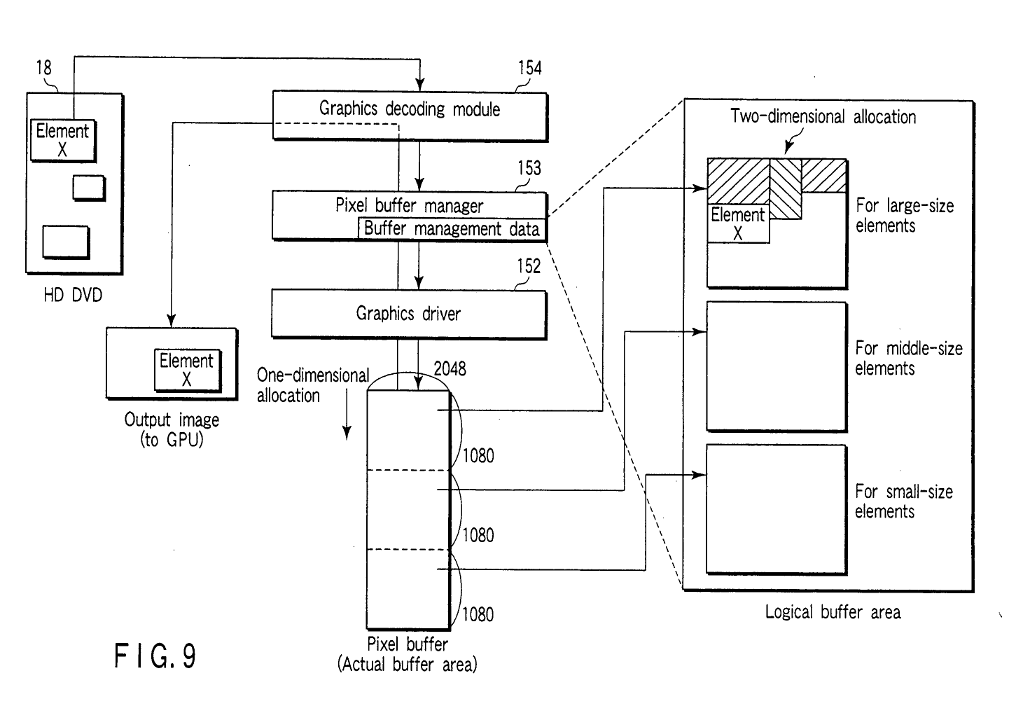

The pixel buffer manager 153 is middleware, which performs allocation control of a pixel buffer used as a work area for drawing pictures by mouse operation using the 3D graphics engine 124 and drawing objects, such as operation guidance by the element decoder 106. Next, an operation principle of the pixel buffer manager 153 is explained with reference to FIG. 9.

The pixel buffer has an actual size enough to ensure at least three areas each having 2048×1080 bits. Further, the pixel buffer manager 153 requests in advance the graphics driver 152 to allocate three areas of 2048×1080 bits to the pixel buffer manager 153.

The graphics driver 152 only performs so-called one-dimensional allocation to sequentially allocate areas of requested sizes from the head of the pixel buffer. The one-dimensional allocation performs no optimization, and thus there is the possibility that available areas are scattered and a new enough continuous available area cannot be secured, although there are enough available areas. Therefore, the pixel buffer 153 receives allocation of almost the whole area of the pixel buffer in advance, and performs, instead of the graphics driver 152, control for allocation requests for the area of the pixel buffer from the graphic decoding module 154, in consideration of optimization.

Suppose that an element X is drawn and displayed by a script contained in navigation data in AV content stored in the HD DVD 18. In this case, the graphics decoding module 154 requests the pixel buffer manager 153 to allocate an area necessary for the element X. On receipt of the request from the graphics decoding module 154, the pixel buffer manager 153 determines which area of the three areas allocated in advance should be used for the allocation, on the basis of the requested size.

The three areas allocated to the pixel buffer manager 153 in advance are an area for elements of large size, an area for elements of middle size, and an area for elements of small size, which have their respective roles. Thereby, elements of almost the same size are allocated to the respective three areas, and thereby optimization is easily performed.

On determining which of the three areas is to be used, the pixel buffer manager 153 then performs allocation of an area of a requested size to the determined area in a two-dimensional manner, that is, allocates a rectangle to the determined area. By performing this two-dimensional allocation, it is possible to apply an algorism to solve a bin packing problem, that is, a combination optimization method to pack a certain amount of objects into the least number of bins. This facilitates optimization of parts of the work area which are not used.

The pixel buffer manager 153 manages information of each allocated rectangle area by four values of (x, y, w, h) as buffer management data. The values x and y indicate an address of the upper left corner of the rectangle, and the values w and h indicate a width and a height of the rectangle, respectively. Further, the address (x, y) in the two-dimensionally allocated rectangle is specified by the following:

y×2048+x+offset value

The graphics decoding module 154 performs drawing of the element X by using the area. When display of the element X ends, the graphics decoding module 154 notifies the pixel buffer manager 153 of release of the used area.

As described above, in the HD DVD player of the present invention, the pixel buffer manager 153 is interposed between the graphics decoding module 154 and the graphics driver 152, and thereby optimization of allocation control of the pixel buffer is achieved.

In the embodiment, explained is the case where the pixel buffer is managed by dividing it into three areas of an area for elements of large size, an area for elements of middle size, and an area for elements of small size. However, performing two-dimensional allocation is the essence of the present invention, and thus area division is not necessarily performed. For example, one large-size area equivalent to almost the whole area of the pixel buffer may be secured, and optimization of allocation control may be performed by using the only one secured area.

Further, the three areas are not required to have the same size, but may have different sizes. For example, the area for elements of large size may be larger than the area for elements of middle size, which may be larger than the area for elements of small size.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A playback apparatus comprising:
a buffer to draw an object including operation guidance to be superposed on a main image;
a graphics driver which controls allocation of an area in the buffer to a host program requesting drawing of the object; and
a buffer managing unit configured to receive allocation of the area in the buffer from the graphics driver, and to allocate the allocated area to the host program, the buffer managing unit being interposed between the host program and the graphics driver.

2. The playback apparatus according to claim 1, wherein the buffer management unit allocates an area requested by the host program to draw the object in a two-dimensional manner to the area allocated from the graphics driver.

3. The playback apparatus according to claim 2, wherein the buffer management unit performs the two-dimensional allocation by using an algorism to solve a bin packing problem.

4. The playback apparatus according to claim 1, wherein the buffer management unit receives allocation of at least two areas from the graphics driver, and a total capacity of the at least two areas almost corresponds to a total capacity of the buffer.

5. The playback apparatus according to claim 4, wherein the buffer management unit determines to which of the at least two areas allocated from the graphics driver the area requested by the host program to draw the object is allocated, based on a capacity necessary for the object.

6. The playback apparatus according to claim 1, wherein the object is irregularly superposed on the main image by a script contained in a moving image stream and described with a markup language.

7. A buffer management method of a playback apparatus including a buffer to draw an object including operation guidance to be superposed on a main image and a graphics driver which controls allocation of an area in the buffer to a host program requesting drawing of the object, comprising:
receiving allocation of the area in the buffer from the graphics driver; and
allocating the allocated area to the host program.

8. The buffer management method according to claim 7, wherein the allocating allocates an area requested by the host program to draw the object in a two-dimensional manner to the area allocated from the graphics driver.

9. The buffer management method according to claim 8, wherein the allocating performs the two-dimensional allocation by using an algorism to solve a bin packing problem.

10. The buffer management method according to claim 7, wherein the allocating receives allocation of at least two areas from the graphics driver, and a total capacity of the at least two areas almost corresponds to a total capacity of the buffer.

11. The buffer management method according to claim 10, wherein the allocating determines to which of the at least two areas allocated from the graphics driver the area requested by the host program to draw the object is allocated, based on a capacity necessary for the object.

12. A buffer management method according to claim 7, wherein the object is irregularly superposed on the main image by a script contained in a moving image stream and described with a markup language.
